(19) United States
(12) Patent Application Publication
(10) Pub. No.: US 2026/0033508 A1
(43) Pub. Date: Feb. 5, 2026

(54) TREATING PERISHABLES WITH AN ETHYLENE-INHIBITING COMPOUND IN CONNECTION WITH A VACUUM ENVIRONMENT

(71) Applicant: Ripelocker LLC, Bainbridge Island, WA (US)

(72) Inventors: George Frank LOBISSER, Bainbridge Island, WA (US); Brendon ANTHONY, Bainbridge Island, WA (US); Yong-Ki KIM, Bainbridge Island, WA (US); Jakob POTT, Bainbridge Island, WA (US)

(73) Assignee: Ripelocker LLC, Bainbridge Island, WA (US)

(21) Appl. No.: 18/791,207

(22) Filed: Jul. 31, 2024

(51) Int. Cl. A23B 7/144; A23B 7/154; A23B 7/157; A23B 7/16

(52) U.S. Cl. CPC A23B 7/144; A23B 7/154; A23B 7/157; A23B 7/16

(57) ABSTRACT

Methods for treating perishable items with an ethylene-inhibiting compound are disclosed herein. The methods may include exposing the perishable items with the ethylene-inhibiting compound in connection with storing the perishable items in a chamber of a vacuum container, the chamber being vacuumed to have a lower internal pressure than ambient pressure external to the vacuum container.

### FIELD

The present disclosure relates to storage of perishables and, more particularly, to treatments of perishables in connection with storage of the perishables in vacuum environments.

### BACKGROUND

A problem that has existed since the dawn of agriculture is that, while the human demand for fruits and vegetables exists year-round, the growing season is seasonal. Many perishable items, such as fruits, vegetables, and flowers can only be grown and/or ripened during specific, typically short, times of the year. Furthermore, such commodities are often grown far from the markets in which they are sold and consumed. The time spent in shipping such perishable commodities reduces the practical time during which the perishable items can be sold and consumed. In the case of certain fruits, such as strawberries, blueberries, etc., the time between when the fruit is ripe for harvest and when it begins to spoil is often short. This creates the dual problems of, for example, having too much of a perishable available during the peak of the harvesting season, and too little available during the off, or non-peak seasons. Much effort has, accordingly, been directed toward extending the post-harvest life of fruits, vegetables, and flowers, and similar perishables intended for human or animal consumption and/or use.

Techniques to control composition of an atmosphere around certain perishable items have been and are practiced at (conventional) atmospheric pressure. For example, it is known that ethylene, which may be generated by certain perishables as they ripen, can cause these perishables, such as apples and bananas, to ripen or can cause other perishable items, such as potatoes, to sprout. Certain perishable items, such as apples and onions, are known to emit ethylene. On the other hand, other gases, such as nitrogen and carbon dioxide, are known to slow decomposition/ripening of certain perishable items.

Apparatuses have been developed to store perishable items in controlled gas conditions at or close to atmospheric pressure. Such apparatuses include warehouses with sealed rooms, containers, and pallets, all of which may be coupled to control systems and gas supplies. One such example commonly used is a controlled atmosphere (CA) room, which may be sealed and where perishable items are exposed to certain compounds and/or gases, generally at ambient atmospheric pressure. The scaled environment, gas supply, and control system of, for example, a CA room may be used to control the composition of an atmosphere around perishable items stored in such a room by introducing a desired composition of gas into the sealed container. In addition, modified atmosphere packaging bags are used to control gas composition around perishable commodities at atmospheric pressure. Control of the atmosphere may be performed to slow ripening until the commodity is close to being sold at which time the composition of gas in the container may be altered to speed ripening.

One known technique for extending the post-harvest life of fruits and vegetables involves placing the perishables in a vacuum for storage. It has been determined that holding perishables in a vacuum of between approximately 10 to 150 Torr (approximately 13 to 200 millibars), potentially in combination with refrigeration, may slow degradation compared to refrigeration alone. However, once the perishables are removed from such a vacuum environment, the degradation of the perishables will substantially increase to the point that their degradation rate will eventually match with the degradation rates of perishables that were not stored in such a vacuum environment. This may be a particular problem in situations where the perishables must be removed from such vacuum environments long before they get to their final destinations, such as the homes of consumers. Thus, there is a need to extend the life of even after they have left the confines of controlled storage environments.

### BRIEF DESCRIPTION OF THE DRAWINGS

FIG. 1 is a graphical representation of the firmness of kiwifruits over a time period after different treatments were applied or not applied to the kiwifruits.

FIG. 2A is a perspective view of an example vacuum container for low-pressure storage of perishable items and constructed according to some embodiments.

FIG. 2B is a perspective view of an example vacuum container for low-pressure storage of perishable items and constructed according to some embodiments.

FIG. 3 is an example method for treating perishable items with an ethylene-inhibiting compound in accordance with various embodiments.

FIG. 4 is a method of exposing perishable items with an ethylene-inhibiting compound in connection with storing the perishable items in a vacuum environment according to some embodiments.

FIG. 5 is another method of exposing perishable items with an ethylene-inhibiting compound in connection with storing the perishable items in a vacuum environment according to some embodiments.

### DETAILED DESCRIPTION

It is well known that ethylene, which is a gascous plant hormone, plays an important role in inducing ripening processes of perishable items, such as fruits, vegetables, and flowers. For example, when certain fruits, such as climacteric fruits (e.g., fruits that continue to ripen after harvest, such as apples, pears, avocados, bananas, mangos, papaya, kiwis, and so forth) ripen, they may emit ethylene as part of their ripening process. Because ethylene promotes the ripening processes of such perishable items, as the concentration of ethylene in the surrounding atmosphere increases, the ripening process accelerates until the perishable items becomes fully ripened and then eventually overripe (e.g., spoils/rots).

Thus, one current way to control the ripening processes of perishable items is to apply an ethylene inhibitor to the perishable items to slow down the generation of ethylene by such perishable items. Such inhibitors are generally applied to perishable items (e.g., by spraying or coating, or by exposing the perishable items to the gaseous form of the inhibitors) in ambient conditions, such as at ambient pressure. Although this has been proven to be somewhat effective in slowing down the ripening process of perishable items, there is still a need to further slow the ripening process of perishable items to extend the shelf life of such perishables.

The inventors of the perishable treatment methods to be described herein for treating perishable items with an ethylene-inhibiting compound have discovered that the efficacy of ethylene-inhibiting compounds in slowing the ripening process of perishable items can be enhanced by applying such compounds to the perishable items in connection with vacuum storage of the perishable items. That is, and in accordance with various embodiments of the present disclosure, treatment methods for treating perishable items such as fruits, vegetables, and flowers with an ethylene-inhibiting compound in connection with a vacuum environment are disclosed herein that may substantially slow down the ripening process and extend the shelf life of perishable items beyond those results that can be conventionally obtained by applying such ethylene-inhibiting compounds in ambient conditions alone. Ethylene-inhibiting compounds are a group of compounds that may inhibit ethylene production by certain perishable items. Examples of ethylene-inhibiting compounds include, for example, 1-methylcyclopropene (1-MCP), silver thiosulfate (STS), and aminocthoxyvinylglycine (AVG). Although these types of compounds are already being applied to perishable items, they are currently applied to perishables at ambient atmospheric conditions such as at ambient pressure (and normal atmospheric air). Note that in the following, “perishable items” and “perishables” may be used interchangeably and are, therefore, synonymous unless indicated otherwise. Further, references to “ethylene-inhibiting compounds” and “inhibitors” may also be used interchangeably and are, therefore, also synonymous unless indicated otherwise.

As noted above, the inventors of the treatment methods to be described herein for treating perishables with ethylene-inhibiting compounds have discovered that by applying such compounds to perishables in connection with vacuum environments, the efficacy of such compounds in slowing the ripening processes of perishables can be improved in comparison to treating such perishables with such compounds at ambient conditions (e.g., ambient pressure). One reason why such methods may work better in extending the shelf life of perishables may be because when such ethylene-inhibiting compounds are applied to the perishables in connection with vacuum environments, the ethylene-inhibiting compounds may penetrate deeper into the perishables, given the rapid gas kinetics and reduced gas diffusion barriers that are enabled under low pressure conditions. Further, in some cases, by carefully controlling the amount and concentration of other gases, such as oxygen (O₂) and carbon dioxide (CO₂), in the vacuum environment, the efficacy of the ethylene-inhibiting compounds can further be enhanced in extending the shelf life of perishables (i.e., synergy).

Ethylene is a natural plant hormone that controls ripening (e.g., transitioning fruit from green to red when ripe, softening the flesh, producing aromas, etc.). As is well-known, ethylene-inhibiting compounds, such as 1-MCP, bind to ethylene receptors of perishables, which inhibits the ability of the perishables to ripen. That is, the molecular structure of ethylene-inhibiting compounds, such as 1-MCP, resembles the molecular structure of ethylene. As a result, 1-MCP molecules are able to bind to the ethylene receptors of perishables, slowing down the ripening process of the perishables. These ethylene-inhibiting compounds can delay and inhibit ripening of variety of perishables including, for example, climacteric and some non-climacteric fruits, as well as vegetables and fruits.

Various ways may be employed for applying an ethylene-inhibiting compound to perishables in connection with vacuum environments in various alternative embodiments. For example, in some embodiments, an ethylene-inhibiting compound may be applied to the perishables while the perishables are in a vacuum environment. In some embodiments, however, the ethylene-inhibiting compound may be alternatively or additionally applied to the perishables before the perishables are placed into or exposed to a vacuum environment. In some embodiments, the ethylene-inhibiting compound may be applied to the perishables 0 to 6 hours before being placed into a vacuum environment. In some other embodiments, the ethylene-inhibiting compound may be applied to the perishables up to 24 hours before being placed into a vacuum environment. For case of explanation and description, the methods in which the ethylene-inhibiting compound is applied to the perishables before the perishables are placed into or exposed to a vacuum environment will be referred to herein as pre-treatment methods, while the methods in which ethylene-inhibiting compound is applied to the perishables while the perishables are in a vacuum environment will be referred to herein as intra-treatment methods.

According to some embodiments of the intra-treatment methods, untreated perishables may be placed into a chamber of a vacuum container, which may then be sealed and vacuumed. In some embodiments, once the sealed chamber has been vacuumed, the ethylene-inhibiting compound in the form of a gas (or as a vaporized spray or mist) can be injected into the chamber. Alternatively, and as will be further described below, a solid form of the ethylene-inhibiting compound, such as the powder form of 1-MCP may be placed into the chamber with the perishables before the chamber is sealed, and by interacting with the moisture drawn out from the perishables in the internal vacuumed atmosphere of the chamber, the moistened 1-MCP will emit gaseous 1-MCP into the internal chamber, exposing the perishables in the chamber to the 1-MCP as will be further described herein.

In the broadest sense, an environment, such as an internal chamber of a vacuum container, may be considered “vacuumed” whenever the gases in the chamber are pumped or vacuumed out such that the internal pressure of the chamber is less than the ambient pressure external to the vacuum container. In some embodiments, to enhance the effect of the ethylene-inhibiting compound on perishables in such a chamber, the chamber may be vacuumed such that the internal pressure of the chamber is between 1 to 500 millibars during, for example, the application of the ethylene-inhibiting compound. Alternatively, and as will be further described with respect to the pre-treatment methods disclosed herein, the perishables may be treated with the ethylene-inhibiting compound before being sealed into a chamber and before the chamber is vacuumed to have an internal pressure of, for example, 1 to 500 millibars.

The actual application of the ethylene-inhibiting compound in a vacuum environment may be accomplished in a variety of different ways. For example, and as noted above, when the ethylene-inhibiting compound is in granular or powdered form such as commercially available 1-MCP, which is commonly contained in sachets, then the ethylene-inhibiting compound (e.g., 1-MCP) may be placed into a chamber of a vacuum container along with the perishables and scaled. As the chamber is vacuumed, moisture is drawn out of the perishables causing the humidity within the chamber to rise. At high humidity, the powdered 1-MCP is activated by exposure to moisture in the air, causing the 1-MCP to “gas out.” As the gascous 1-MCP is absorbed by the perishables, the concentration of the 1-MCP in the chamber will eventually diminish until the 1-MCP in the internal atmosphere is absorbed by the perishables. The amount of time it takes for the 1-MCP to be fully absorbed by the perishables will depend on a number of factors including the amount of 1-MCP (or other ethylene-inhibiting compound) that was originally placed into the chamber, the amount of perishables in the chamber, the size of the chamber, the gascous composition of the chamber, temperature, and so forth.

In some embodiments, to enhance the effects of the ethylene-inhibiting compounds to extend the shelf life of perishables, other gases may be injected or extracted from the vacuum chamber. For example, in some embodiments, the concentration or amount of a gas such CO₂ in the vacuum chamber may be allowed to naturally rise from the respiration of the perishables, which may further slowdown the ripening process of the perishables. Alternatively, or additionally, the CO₂ may be injected into the vacuum chamber to slowdown the ripening process of the perishables. In the same or alternative embodiments, the oxygen contained in the vacuum chamber may be extracted, without replacing it with other gases, such that oxygen makes up only about five percent and nitrogen makes up about 94-95 percent of the gas mixture in the chamber (in contrast atmospheric air comprises about 78 percent nitrogen, 21 percent oxygen, and a small of other gases). Note that there may be trace amounts of other gases in the chamber such as water vapor and other gases (e.g., atmospheric air contains about 78 percent nitrogen, 21 percent oxygen, about 1 percent argon, and trace amounts of CO₂ and varying amounts of water vapor. In some embodiments, the gaseous content of the chamber may be controlled such that 10-15 percent of the gaseous content of the chamber is CO₂ (e.g., 12 percent CO₂, 5 percent O₂, and nitrogen and other gases making up the rest the gaseous content).

As briefly described above, in pre-treatment methods for treating perishables, an ethylene-inhibiting compound is applied to the perishables before the perishables are placed into or exposed to a vacuum environment. In these methods, the ethylene-inhibiting compound may be applied to the perishable in a variety of different ways. For example, in some implementations, the ethylene-inhibiting compound may be sprayed onto the perishables as a solution just before being placed into, for example, a chamber of a vacuum container, which is then sealed and vacuumed. Alternatively, the perishables before being placed into a vacuum environment (e.g., placed into a chamber of a vacuum container, which is then sealed and vacuum), may be exposed to a gaseous form of the ethylene-inhibiting compound under ambient conditions (e.g., ambient pressure) in a containment room, such as a controlled atmosphere (CA) room.

In some embodiments, untreated perishables may be treated with an ethylene-inhibiting compound just before (e.g., within 24 hours of) being placed into a vacuum environment. In various embodiments, the vacuum environment (e.g., internal pressure of a chamber of a vacuum container that the pre-treated perishables are placed into) may be vacuumed to have a pressure of between 1 and 500 millibars. Note that the application of ethylene-inhibiting compounds to perishables, regardless of whether a pre-treatment or an intra-treatment is employed, may have lasting effects in slowing down the ripening processes of the perishables long after the completion of the ethylene-inhibiting compound treatment, which can have significant benefits when the final destinations of the perishables are spatially and/or temporally far away from the ethylene-inhibiting compound treatment location and/or time.

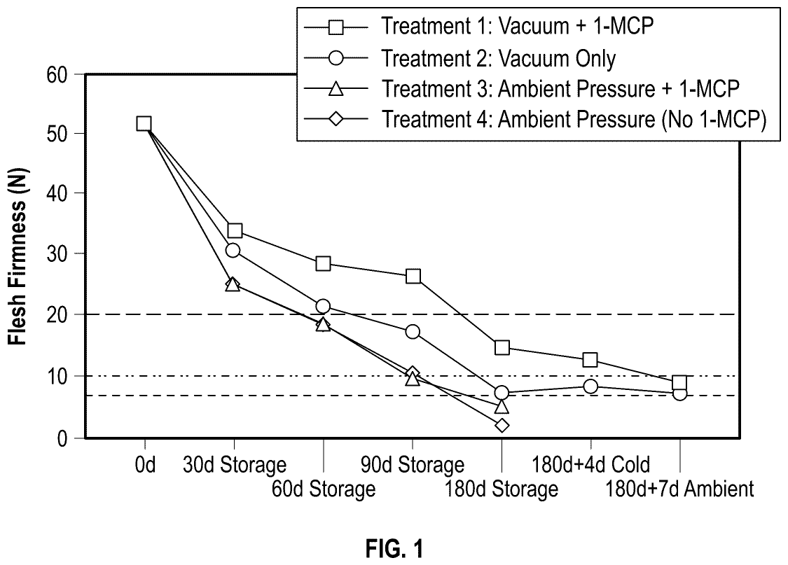

Referring to FIG. 1, which is a graphical depiction of the firmness of kiwifruit over a period of time after different treatments were applied or not applied to the kiwifruit. More particularly, FIG. 1 shows the results of trials that were conducted to track, during the course of several months, the firmness of Mega Kiwi fruit (a specific variety of kiwifruit that has been bred for its large size), after they were treated with 1-MCP treatment and/or vacuum storage treatment, and when no vacuum and no 1-MCP treatment were applied (e.g., “control” group). The four treatments that were tracked were:
Treatment 1: A group of Mega Kiwi fruit were treated with 1-MCP in vacuum (solid line with squares).
Treatment 2: A group of Mega Kiwi fruit were treated with vacuum only without 1-MCP treatment (solid line with circles).
Treatment 3: A group of Mega Kiwi fruit were treated with 1-MCP at ambient pressure (solid line with triangles).
Treatment 4: This is the control group where neither vacuum nor 1-MCP treatments were applied. (solid line with diamonds).

The firmness of certain fruits, such as Mega Kiwi fruit, may be indicative of their ripeness stage, which are commonly measured in Newtons (N).

In treatments 1 and 3 where 1-MCP was applied to the Mega Kiwi fruit, a sachet of 1-MCP (e.g., commercially available 1-MCP is typically in a powdered or granular form that is placed in sachets containing different amounts of 1-MCP) was placed into a chamber containing the fruits, and the chamber was sealed and vacuumed in treatment 1, or was placed into a chamber containing the fruit and the chamber was left under ambient pressure in treatment 3. In the case of treatment 2, the fruits were stored in vacuum for several months without 1-MCP, while in treatment 4, fruits were stored under ambient conditions without 1-MCP. In each treatment 1, 2, and 3, as well as the control in treatment 4, the firmness of the fruits were checked periodically.

More specifically, in the trial, after 30, 60, 90 and 180 days of storage at 0° C., whether under vacuum conditions (60 mbar) or at ambient pressure (1,010 mbar—note that atmospheric pressure at sea level is 1,013 mbar), the fruit were removed from their respective treatment environments and assessed for their firmness in Newtons (N). In this trial, when the Mega Kiwi fruit were stored in vacuum conditions such as in treatments 1 and 2, environmental pressure was maintained in a low-pressure environment (e.g., 60 mbars) with low O₂ level (e.g., around eight percent of total environmental gaseous composition) and with moderate CO₂ level (e.g., around thirteen percent of total environmental gaseous composition) for the entirety of the storage duration. The “control” fruits in treatment 4 were stored in normal or regular atmospheric (RA) conditions (˜20% O₂, 3 ppm CO₂). As noted above, the 1-MCP to be applied in treatments 1 and 3, for example, were in a powdered or granular form that were contained in a sachet, which permits the powered or granular form of the 1-MCP to volatize as a gas once under high humidity conditions. For the trials (e.g., treatments 1 and 3) one sachet (Hazel 100™, which is manufactured by Hazel Technologies, Fresno, CA) was used for every 10 kg of fruit.

Note that in treatments 1 and 3 where the fruits were exposed to 1-MCP in an enclosed environment under vacuum or under ambient pressure, the concentration of the gaseous 1-MCP in the sealed environment dissipated as the gaseous 1-MCP was absorbed into the fruits so that after a couple of days, only a residual amount of the 1-MCP may be present in the sealed environment.

In FIG. 1, the initial firmness of the trial fruits were measured at 0 days (d) of storage. This was the firmness of when the fruits were being loaded into their respective storage treatments. After 30 days, all the trial fruit showed different degrees of reduction in firmness. However, those trial fruit in the treatments that stored the fruit under ambient pressure (e.g., treatments 3 and 4 with the broken black lines) showed substantially greater reduction in firmness than the trial fruit that were in the treatments that entailed storing the fruit in vacuum (e.g., treatments 1 and 2 with the solid black lines). That is, fruit that were stored in vacuum conditions with or without 1-MCP treatment fared much better in maintaining firmness than those fruit that were stored at ambient pressure, even though one of those ambient pressure treatments had still received an ethylene inhibition treatment (i.e., 1-MCP alone at ambient pressure did help fruit retain firmness after three to six months of storage).

In FIG. 1, there are three horizontal dashed lines that reflect the acceptable shipping firmness thresholds of the fruit at different stages of the supply chain, from harvest to consumers. The first firmness threshold is at 20 N, which is the “shipping” threshold, the second threshold is at 10 N, which is the “retailer” threshold, and the third threshold is at 7 N, which is the “consumption” threshold.

As illustrated, after 90 days of storage, those fruit that were stored at ambient pressure (e.g., treatments 3 and 4 with and without 1-MCP treatments) had firmness that were well below the shipping threshold of 20 N. Meanwhile, the fruit that were treated with vacuum without 1-MCP had firmness just below the shipping threshold., while the fruit treated with both vacuum plus 1-MCP had firmness that was well above the 20 N shipping threshold.

After 180 days of storage, all treatments were below the retail threshold (10 N), with the exception of the vacuum plus 1-MCP treatment, which remained above this line. After the 180 days and after additional four days (4 d) of “shelf life” at 0° C., fruits from both ambient pressure treatments (e.g., treatments 3 and 4) were disqualified, but fruit from both vacuum treatments (e.g., treatments 1 and 2) were held longer, as they were above the consumption threshold of 7 N. These fruits from treatments 1 and 2 were moved to ambient temperature conditions (20° C.) and re-evaluated again, to simulate the time from retailer to the consumer's home. Both treatments softened and arrived at this target, but the rate of this softening was dramatically slowed with the addition of 1-MCP under vacuum conditions.

In short, the benefit of vacuum conditions alone (without 1-MCP) are realized throughout the storage duration, as it provides a benefit in firmness retention. The ambient pressure combinations (e.g., treatments 3 and 4) each behaved similarly, regardless of 1-MCP treatment. This underscores the lack of efficacy and/or consistency of 1-MCP when applied in this context. But, when 1-MCP is applied under vacuum conditions, a synergistic benefit is realized, providing significantly better efficacy in firmness retention than just vacuum alone.

Vacuum conditions plus 1-MCP results in a unique and extraordinary benefit with respect to the inhibition of kiwifruit ripening and softening (i.e., firmness loss). That is, the treatment of the fruit with 1-MCP in combination with vacuum storage greatly extends the shelf life of the fruits. This phenomenon is further highlighted by the fact that the Mega Kiwi variety is notorious for softening/spoiling quickly (current practice storage cannot exceed three months), when compared to other varieties, such as the Hayward variety, the industry standard (current practice storage regularly exceed six months).

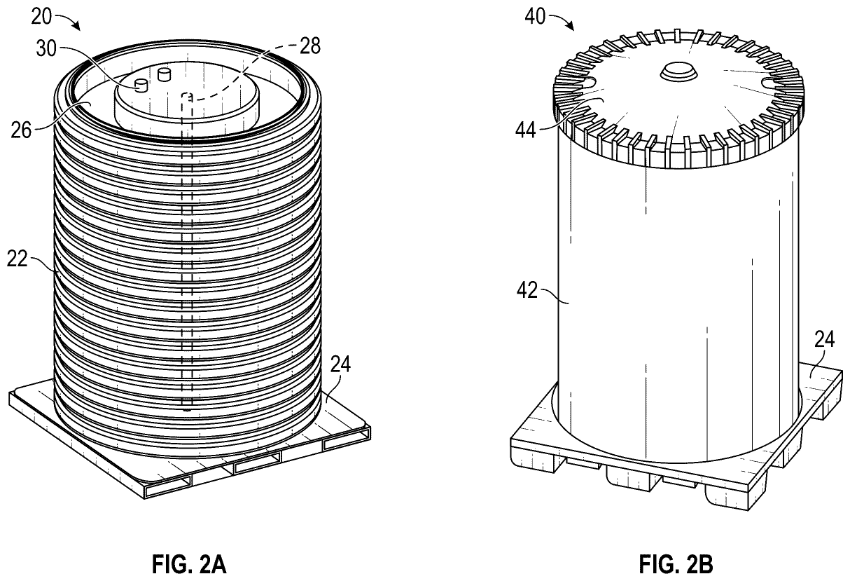

FIG. 2A is a perspective view of an example vacuum container for low-pressure storage of perishable items and constructed according to some embodiments. As shown in FIG. 2A, the vacuum container, which in this case, is a cylindrical vessel 20, includes a section of cylindrical large diameter corrugated plastic drainage pipe 22 (hereinafter “pipe 22”) having one, two, or three thinner layers of walls. The pipe 22 may be formed of a polymer, such as polypropylene (PP), high-density polyethylene (HDPE), or polyvinyl chloride (PVC). Each layer of material may range from 0.05″ to 0.25″. Where the material join together, the total wall thickness may exceed ¼″. The diameter of the pipe 22 may be between 30 and 48 inches in some embodiments so as to fit on most common pallets. In some embodiments, the height of the cylindrical vessel 20 may range from 12 to 80 inches, common to most pallet shipments or perishables storage.

As further illustrated in FIG. 2A, the pipe 22 rests on a generally square or rectangular pallet 24 that may be formed of carbon reinforced HDPE. In the illustrated embodiment, the pallet 24 is generally square and configured to be transported by standard fork trucks. The upper end of the pipe 22 is fitted with a generally circular flat top or lid 26 that, after placement over the top end of the pipe 22, is sealed so as to permit the formation of a vacuum within the vessel 20. A scal is also provided between the lower end of the pipe 22 and the upper surface of the pallet 24 to help maintain the vacuum.

As further illustrated in FIG. 2A, the vessel includes an interior support 28 that, in the illustrated embodiment, consists of a rigid cylindrical rod extending upwardly along the central axis of the pipe 22 from the top of the pallet 24 to the underside of the top or lid 26. The support can be formed of other suitable, rigid materials such as metal or higher performance composites. Various ports 30 may be provided in the top or lid 26 to permit the attachment of such apparatus as vacuum pumps, sensors, gas inlets and other devices for monitoring and controlling the atmosphere within the vessel 20. Note that in various embodiments, the top or lid 26 may permit attachment of apparatuses that are able to inject into the vessel 20 a vaporized spray or a mist of a solution containing an ethylene-inhibiting compound.

FIG. 2B is a perspective view of another example vacuum container for low-pressure storage of perishable items and constructed according to some embodiments. In the embodiment illustrated in FIG. 2B, the vacuum container, which again is a cylindrical vessel 40. wherein the pipe 42 is of a single layer configuration and wherein the top or lid 44 is of a convex shape. Again, the top or lid 44 and the upper section of the pipe 42 are detachably sealed to each other to maintain a vacuum within the vessel 40, as are the lower portion of the pipe 42 and the pallet 24 on which the pipe 42 rests. The convex shape of the top or lid 44 helps withstand the external pressures resulting from the formation of a vacuum within the vessel 40 that allows the central support to be dispensed with. Alternatively, the central support can be included to further withstand the pressures that result. Furthermore, the lid 44 can be concave in shape resulting in a state of tensile stress as opposed to compressive.

Although not illustrated in FIGS. 2A and 2B, each of the vessels 20 and 40 includes a chamber for storing or holding, at least temporarily, perishables in a vacuum environment. These vessels 20 and 40 are mobile and may be used to transport perishables in a vacuum environment to slow their ripening process even while they are being transported to market. Using mobile vacuum containers, such as the vessels 20 and 40 illustrated in FIGS. 2A and 2B, which were described in U.S. patent application Ser. No. 15/923,611, filed on Mar. 16, 2018, issued as U.S. Pat. No. 11,008,151 on May 18, 2021, entitled CYLINDRICAL VESSEL FOR LOW PRESSURE STORAGE OF PERISHABLE GOODS FABRICATED FROM NEAT OR REINFORCED PLASTICS naming as inventor G. Kyle Lobisser and which is hereby incorporated by reference in its entirety, may be particularly beneficial for treating perishables with an ethylene-inhibiting compound in connection with a vacuum environment, as described herein, since such treatments can be done nearer to the final temporal and/or spatial destination of the perishables.

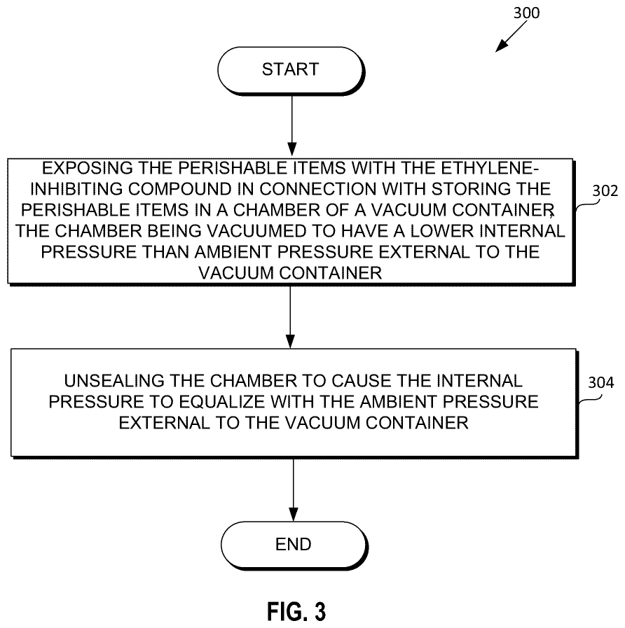

Referring to FIG. 3, which is an example method for treating perishable items with an ethylene-inhibiting compound in accordance with various embodiments. To facilitate understanding of the methods to be described hereinafter, references may be to the vacuum containers (e.g., cylindrical vessels 20 and 40 of FIGS. 2A and 2B) as examples of how various operations may be performed using such vacuum containers. That is, in various embodiments, method 300 may at least be partly implemented using a vacuum container, such as the cylindrical vessel 20 or 40 of FIGS. 2A or 2B.

The method 300 may begin when an exposure operation 302 is performed for exposing the perishable items with the ethylene-inhibiting compound in connection with storing the perishable items in a chamber of a vacuum container, the chamber being vacuumed to have a lower internal pressure than ambient pressure external to the vacuum container. For instance, exposing the perishable items with the ethylene-inhibiting compound (e.g., 1-MCP, STS, or AVG) prior to and/or while storing the perishable items, such as fruits, vegetables, and/or flowers, in a chamber of a vacuum container, such as a cylindrical vessel 20 or 40 of FIGS. 2A or 2B. In various embodiments, the chamber is vacuumed to have a lower internal pressure than the ambient pressure external to the vacuum container. Thus, in accordance with various embodiments, the perishable items may be exposed to the ethylene-inhibiting compound in connection with storing the perishable items in a vacuumed chamber by treating the perishable items with the ethylene-inhibiting compound before the perishable items are stored in a vacuumed environment or during storage in a vacuumed environment as described herein.

The phrase “treatment,” “treating,” or variations thereof may be in reference to perishables being exposed to, for example, a gascous form of an ethylene-inhibiting application, or if the ethylene-inhibitor compound is in a liquid/solution form then coating or spraying the ethylene-inhibiting compound onto the perishable or soaking the perishables into a solution of ethylenc-inhibiting compound.

As noted above, in various embodiments, the perishable items to be exposed to the ethylene-inhibiting compound may include fruits, vegetables, and/or flowers. For example, in some embodiments, the perishable items may include climacteric fruits such as apples, pears, blueberries, tomatoes, avocados, kiwifruits, peaches/nectarines, bananas, mangoes, papayas, breadfruit, peppers, and so forth. In the same or alternative embodiments, the perishable items may include non-climacteric fruits such as citrus fruits including grapefruits, oranges, mandarins, limes and lemons, berries such as raspberries, strawberries, blackberries, cherries, grapes, pineapples, melons, pomegranates, plums, and so forth. In the same or alternative embodiments, the perishable items may include vegetables such as broccoli, asparagus, lettuces, spinach, basil and other culinary herbs (cilantro, parsley, mint). In the same or alternative embodiments, the perishable items may include flowers such as roses, veronicas, carnations and hops.

In various embodiments, when the ethylene-inhibiting compound is 1-MCP then exposing the perishable item with the ethylene-inhibiting compound may entail exposing the perishable items in the chamber that has been vacuumed and with an internal gas mixture comprising 0.015 to 10 parts per million (PPM) of 1-MCP. In some embodiments, the perishable items in the chamber may be exposed to an internal gas mixture of the chamber that comprises 0.5 PPM to 1.5 PPM of 1-MCP.

To control the gas concentration of the 1-MCP, the amount of, for example, powdered or granular form of 1-MCP that may be placed in the chamber prior to the chamber being sealed and vacuumed with the perishable items may be carefully measured and inserted into the chamber based, at least in part, on the volume of the chamber, the amount and type of perishables to be included/treated in the chamber, and so forth. That is, the amount of powdered or granular 1-MCP to be placed into a chamber to obtain the desired gas concentration level will depend on a number of factors. Further, it has been determined that a relatively higher concentration of 1-MCP in the vacuum chamber does not necessarily improve the efficacy of the 1-MCP relative to a lower concentration of 1-MCP. Instead, relatively low levels of 1-MCP concentrations (e.g., 0.015 to 10 PPM of 1-MCP) in the vacuumed chamber was shown to be just as effective, if not more effective, in extending the shelf life of the perishable items then using higher gaseous levels or concentrations of 1-MCP.

In some embodiments, and as noted above, the operation for exposing the perishable items with the 1-MCP may include placing powdered or granular form of the 1-MCP with the perishable items into the chamber of the vacuum container (e.g., cylindrical vessels 20 and 40 of FIGS. 2A and 2B) prior to the chamber being sealed and vacuumed.

In some embodiments, the ethylene-inhibiting compound that the perishable items are exposed to may include silver thiosulfate (STS) or aminocthoxyvinylglycine (AVG).

In various embodiments, the ethylene-inhibiting compound that (e.g., 1-MCP, STS, or AVG) that the perishable items are exposed to may be in a gaseous or vapor form that may be applied to the perishable items after the chamber of the vacuum chamber has been scaled. Alternatively, the ethylene-inhibiting compound, when applied to the perishable items prior to the perishable items being vacuumed sealed in a chamber of a vacuum container or when applied to the perishable items while being stored in the sealed chamber may be in the form of a mist or spray. In still other embodiments in which the ethylene-inhibiting compound is applied to the perishable items prior to being stored in a vacuumed chamber, the ethylene-inhibiting compound may be applied to the perishable items as a fluid or solution by spraying or coating the ethylene-inhibiting compound onto the perishable items, or alternatively, may be applied to the perishable items in a gaseous form at ambient pressure in a, for example, CA room.

As previously noted, in various embodiments, the exposing of the perishable items with the ethylene-inhibiting compound in connection with storing the perishable items in the chamber of a vacuum container may entail applying the ethylene-inhibiting compound to the perishable items prior to the perishable items being vacuumed sealed in the chamber (e.g., sealed into the chamber of a vacuum container, which is then vacuumed to cause the internal pressure of the chamber to be less than the ambient pressure external to the vacuum container).

In various embodiments, the exposing of the perishable items with the ethylene-inhibiting compound in connection with storing the perishable items in a chamber of a vacuum container includes exposing the perishable items with the ethylene-inhibiting compound in connection with storing the perishable items in a chamber of a vacuum container that is vacuumed to have an internal pressure of between 1 and 500 millibar. That is, and in accordance with some embodiments, the exposure of the perishable items with the ethylene-inhibiting compound that may occur before or during storage of the perishable items in the chamber of the vacuum chamber, wherein the chamber may be vacuumed to have an internal pressure of between 1 and 500 millibar during the storage of the perishable items in the chamber in at least some embodiments.

In some embodiments, the exposing of the perishable items with the ethylene-inhibiting compound in connection with storing the perishable items in a chamber of a vacuum container includes injecting into the chamber CO₂ gas, It is known that CO₂ can slow down ripening of perishables, such as fruits, when they exceed certain levels such as 1% (10,000 ppm). And although perishables can expel CO₂ as part of their respiration process, to rapidly increase the CO₂ levels in the sealed chamber, CO₂ may be injected into the chamber.

In some embodiments, the exposing of the perishable items with the ethylene-inhibiting compound in connection with storing the perishable items in a chamber of a vacuum container includes removing oxygen in the chamber without replacing the removed oxygen with another gas in the vacuumed chamber. In some cases, the removing of oxygen in the chamber without replacing the removed oxygen with another gas includes removing the oxygen from the chamber such that five percent of the gaseous content of the chamber is oxygen. Examples of systems and methods for controlling oxygen levels in a sealed vacuum chamber are disclosed in U.S. patent application Ser. No. 15/923,529, filed on Mar. 16, 2018, issued as U.S. Pat. No. 10,919,656 on Feb. 16, 2021 entitled PROCEDURES FOR OPERATING A VACUUM TO STORE PERISHABLES BY CONTROLLING PRESSURE AND OXYGEN LEVELS INDEPENDENT OF EACH OTHER AS WELL AS SETTING FLOOR AND CEILING OPERATING PARAMETERS naming as inventors George Frank Lobisser, Kyle Lobisser, Todd Hansen, Eric Levi, and Justin Chase Botthell, which is hereby incorporated by reference in its entirety.

In some embodiments, the removal of the oxygen in the chamber without replacing the removed oxygen with another gas includes removing the oxygen from the chamber (e.g., the chamber of cylindrical vessel 20 of FIG. 2A) such that five percent (±2 percent) of the gaseous content of the chamber is oxygen (in contrast, atmospheric air typically contains 21 percent oxygen). For these embodiments, the other gases that may be included in the chamber may primarily include nitrogen, and smaller amounts of CO₂, water vapor, and other gases. In some alternative embodiments, the oxygen in the chamber may be removed such that ten percent (±5 percent) of the gaseous content of the chamber is oxygen. For these embodiments, maintaining relatively low oxygen levels in the chamber may extend the shelf life of the perishables. However, the optimal oxygen level may differ depending on a number of factors such as type of perishables, chamber pressure and temperature, and so forth.

Referring back to method 300 of FIG. 3, method 300 may further include an unscaling operation 302 for unsealing the chamber (e.g., the chamber of cylindrical vessel 20 or 40 of FIG. 2A or 2B) to cause the internal pressure of the chamber to equalize with the ambient pressure external to the vacuum container. The unsealing of the chamber may be for various reasons including, for example, removing the perishable items form the chamber, to vent out the gases in the chamber, to check the conditions of the perishable items, to insert additional ethylene-inhibiting compound such as the powdered form of 1-MCP into the chamber, and so forth.

In some embodiments, the unsealing of the chamber may occur after at least one hour of the perishable items being stored in the chamber. In some embodiments, the unscaling of the chamber may occur after at least 12 hours of the perishable items being stored in the chamber. In still other embodiments, however, the unsealing of the chamber may occur after at least 48 hours of the perishable items being stored in the chamber.

In some embodiments, after unsealing the chamber, the chamber may then be resealed and vacuumed again to between, for example 1 to 500 mbars for long term storage. In some embodiments, during the long-term storage (e.g., one to six months), the perishable items may be periodically exposed to during the long-term storage to the same ethylene-inhibiting compound that the perishable items were initially exposed to or a different ethylene-inhibiting compound. The periodic application of the ethylene-inhibiting compound can be accomplished in a number of different ways. For example, in some cases, each time the stored perishable items need to be exposed to an ethylene-inhibiting compound, the chamber may be unsealed and an ethylene-inhibiting compound in powdered form may be placed into the chamber and rescaled.

Alternatively, a gaseous or mist form of the ethylene-inhibiting compound may be injected into the sealed chamber. In other cases, however, the chamber may be unsealed, the perishable items removed from the chamber to apply the ethylene-inhibiting compound in ambient conditions (e.g., at ambient pressure), and then the treated perishable items placed back into the chamber for vacuum storage again.

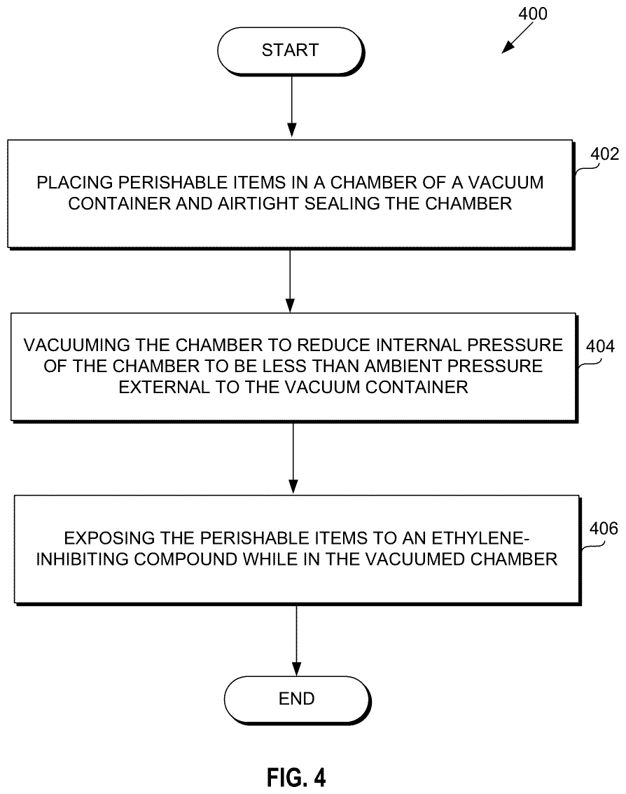

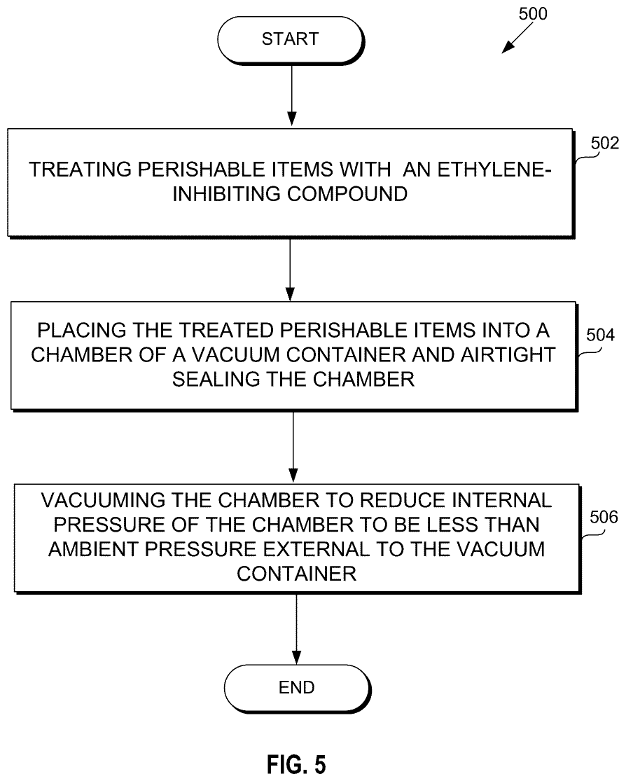

FIGS. 4 and 5 illustrates two alternative methods for exposing perishable items with an ethylene-inhibiting compound in connection with storing the perishable items in a vacuum environment according to various embodiments. More particularly, FIG. 4 is a high-level intra-treatment method 400 for treating perishable items with an ethylene-inhibiting compound while the perishable items are stored in a vacuum environment, while FIG. 5 is a high-level pre-treatment method 500 for treating perishable items with an ethylene-inhibiting compound prior to the perishable items being stored in a vacuum environment. In some embodiments, the intra-treatment method 400 of FIG. 4 and the pre-treatment method 500 of FIG. 5 may be alternative methods for implementing the exposure operation 302 of FIG. 3. Note that for purposes of the following both operation for exposing perishables with an ethylene-inhibiting compound and storing the perishables in a vacuum environment may each be considered treatments for extending the shelf life of the perishables.

Turning particularly now to the intra-treatment method 400 of FIG. 4, the intra-treatment method 400 may begin when a placing operation 402 may be performed for placing perishable items in a chamber of a vacuum container and airtight sealing the chamber. For instance, placing fruits, vegetables, and/or flowers into the chamber of the cylindrical vessel 20 of FIG. 2A, and scaling the chamber to, for example, prevent gases external to the chamber of the vacuum container from entering the chamber.

Next, a vacuuming operation 404 may be performed for vacuuming the chamber to reduce internal pressure of the chamber to be less than ambient pressure external to the vacuum container. For instance, after placing the fruits, vegetables, and/or flowers into the chamber of the cylindrical vessel 20, vacuuming the chamber so that the internal pressure of the chamber is between 1-500 mbars.

Finally, an exposing operation 406 may be performed for exposing the perishable items to an ethylene-inhibiting compound while in the vacuumed chamber. For example, in some cases the exposing operation may be performed by simply placing into the chamber, with the perishable items, a powdered or granular form an ethylene-inhibiting compound, such as 1-MCP, which when interacting with the water vapor drawn out of the perishable items in the vacuum environment, emit the gaseous form of the ethylene-inhibiting compound into the sealed chamber. Alternatively, a gaseous or mist form of the ethylene-inhibiting compound can be injected into the chamber while the chamber is vacuumed.

In some embodiments, the ethylene-inhibiting compound may be the granular or powdered form of 1-MCP (which may be contained in one or more sachets) that may be placed into the chamber with the perishable item prior to the chamber being airtight sealed. In other embodiments, however, the ethylene-inhibiting compound may be a solution of STS or AVG that may be applied as an acrosol or vaporized liquid to the perishable items while the perishable items are in the vacuumed chamber.

In various embodiments, the vacuuming operation 404 may entail vacuuming the chamber so that the chamber has an internal pressure of between 1 to 500 millibars. In some embodiments, the vacuuming of the chamber includes injecting carbon dioxide (CO₂) into the chamber. Alternatively, or additionally, the concentration of the CO₂ in the chamber may be allowed to increase “naturally” through the respiration of the perishables. In the same or alternative embodiments, the vacuuming of the chamber may include controlling the gaseous composition of the chamber so that concentration of oxygen (O₂) in the chamber is ten percent (±5 percent) of the total gas composition of the chamber.

Referring to the pre-treatment method 500 of FIG. 5 for treating perishable items with an ethylene-inhibiting compound prior to the perishable items being stored in a vacuum environment. For the embodiments, the pre-treatment method 500 may begin when a treatment operation 502 is performed for treating perishable items with an ethylene-inhibiting compound (e.g., 1-MCP, STS, or AVG). In some embodiments may be treated with the ethylene-inhibiting compound by exposing the perishable items to a gaseous form of the ethylene-inhibiting compound under ambient pressure. Alternatively, the perishable items may be coated or sprayed with the ethylene-inhibiting compound under, for example, ambient conditions.

Next, a placing operation 504 may be performed for placing the treated perishable items into a chamber of a vacuum container and airtight sealing the chamber such that external air does not leak into the chamber. And finally, a vacuuming operation 506 may be performed for vacuuming the chamber to reduce internal pressure of the chamber to be less than ambient pressure external to the vacuum container. In some embodiments, the chamber may be vacuumed such that the internal pressure of the chamber is between 1 to 500 millibars.

In some embodiments, the perishable items may be treated with the ethylene-inhibiting compound by spraying or coating the perishable items with a solution of the ethylene-inhibiting compound. Alternatively, the perishable items may be treated with the ethylene-inhibiting compound by exposing the perishable items with a gaseous form of the ethylene-inhibiting compound at, for example, ambient pressure in a CA room.

After reviewing the present disclosure, an individual of ordinary skill in the art will immediately appreciate that some details and features can be added, removed and/or changed without deviating from the spirit of the invention. Reference throughout this specification to “one embodiment,” “an embodiment,” “additional embodiment(s)” or “some embodiments,” means that a particular feature, structure or characteristic described in connection with the embodiment(s) is included in at least one or some embodiment(s), but not necessarily all embodiments, such that the references do not necessarily refer to the same embodiment(s). Furthermore, the particular features, steps, structures, or characteristics may be combined in any suitable manner in one or more embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A method for treating perishable items with an ethylene-inhibiting compound, comprising:
exposing the perishable items with the ethylene-inhibiting compound in connection with storing the perishable items in a chamber of a vacuum container, the chamber being vacuumed to have a lower internal pressure than ambient pressure external to the vacuum container; and
unsealing the chamber to cause the internal pressure to equalize with the ambient pressure external to the vacuum container of the perishable items being stored in the chamber.

2. The method of claim 1, wherein exposing the perishable items with the ethylene-inhibiting compound includes exposing at least one of fruits, vegetables, or flowers with the ethylene-inhibiting compound.

3. The method of claim 1, wherein exposing the perishable items with the ethylene-inhibiting compound includes exposing the perishable items with 1-Methylcyclopropene (1-MCP).

4. The method of claim 3, wherein exposing the perishable items with 1-MCP includes exposing the perishable items in the chamber that has been vacuumed and with a gas mixture comprising 0.015 to 10 parts per million (PPM) of 1-MCP.

5. The method of claim 4, wherein the perishable items in the chamber are exposed to a gas mixture comprising 0.5 PPM to 1.5 PPM of 1-MCP.

6. The method of claim 3, wherein exposing the perishable items with the 1-MCP includes placing powdered or granular form the 1-MCP with the perishable items into the chamber prior to the chamber being sealed and vacuumed.

7. The method of claim 1, wherein exposing the perishable items with the ethylene-inhibiting compound includes exposing the perishable items with silver thiosulfate (STS) or aminoethoxyvinylglycine (AVG).

8. The method of claim 1, wherein exposing the perishable items with the ethylene-inhibiting compound includes exposing in the chamber the perishable items with the ethylene-inhibiting compound that is in gaseous or vapor form.

9. The method of claim 1, wherein exposing the perishable items with the ethylene-inhibiting compound includes applying the ethylene-inhibiting compound to the perishable items prior to being vacuumed sealed in the chamber.

10. The method of claim 9, wherein applying the ethylene-inhibiting compound to the perishable items prior to being vacuumed sealed in the chamber includes coating or spraying the ethylene-inhibiting compound onto the perishable items.

11. The method of claim 9, wherein applying the ethylene-inhibiting compound to the perishable items prior to being vacuumed sealed in the chamber includes exposing the perishable items to vapor or gaseous form of the ethylene-inhibiting compound under ambient pressure prior to being vacuum sealed in the chamber.

12. The method of claim 1, wherein exposing the perishable items with the ethylene-inhibiting compound in connection with storing the perishable items in a chamber of a vacuum container includes exposing the perishable items with the ethylene-inhibiting compound in connection with storing the perishable items in a chamber of a vacuum container that is vacuumed to have an internal pressure of between 1 and 500 millibar.

13. The method of claim 1, wherein exposing the perishable items with the ethylene-inhibiting compound in connection with storing the perishable items in a chamber of a vacuum container includes removing oxygen in the chamber without replacing the removed oxygen with another gas.

14. The method of claim 13, wherein removing oxygen in the chamber without replacing the removed oxygen with another gas includes removing the oxygen from the chamber such that five percent of the gaseous content of the chamber is oxygen.

15. The method of claim 1, wherein unsealing the chamber includes unsealing the vacuum chamber after at least one hour.

16. The method of claim 15, wherein unsealing the chamber includes unsealing the chamber after at least 48 hours.

17. A method for treating perishable items with an ethylene-inhibiting compound, comprising:
placing the perishable items in a chamber of a vacuum container and airtight sealing the chamber;
vacuuming the chamber to reduce internal pressure of the chamber to be less than ambient pressure external to the vacuum container; and
exposing the perishable items to the ethylene-inhibiting compound while in the vacuumed chamber.

18. The method of claim 17, wherein vacuuming the chamber includes controlling the gaseous composition of the chamber so that concentration of oxygen (O₂) in the chamber is five percent.

19. A method for treating perishable items with an ethylene-inhibiting compound, comprising:
treating the perishable items with the ethylene-inhibiting compound;
placing the treated perishable items into a chamber of a vacuum container and airtight sealing the chamber; and
vacuuming the chamber to reduce internal pressure of the chamber to be less than ambient pressure external to the vacuum container.

20. The method of claim 19, wherein vacuuming the chamber to reduce internal pressure of the chamber includes vacuuming the chamber so that the chamber has an internal pressure of between 1 to 500 millibars.
